(19) United States
(12) Patent Application Publication
(10) Pub. No.: US 2025/0223206 A1
(43) Pub. Date: Jul. 10, 2025

(54) ROTATING PACKED BED WITH NOVEL STRUCTURE

(71) Applicant: North University of China, Taiyuan City, Shanxi Province (CN)

(72) Inventors: Weizhou JIAO, Taiyuan City (CN); Ruize SHANG, Taiyuan City (CN); Youzhi LIU, Taiyuan City (CN); Guisheng QI, Taiyuan City (CN); Chao ZHANG, Taiyuan City (CN); Zhiguo YUAN, Taiyuan City (CN); Qiaoling ZHANG, Taiyuan City (CN)

(21) Appl. No.: 19/009,261

(22) Filed: Jan. 3, 2025

(30) Foreign Application Priority Data
Jan. 9, 2024 (CN) 202410026911.5

(51) Int. Cl. C02F 1/72

(52) U.S. Cl. CPC C02F 1/725; C02F 2201/004; C02F 2201/78

(57) ABSTRACT

Provided is a rotating packed bed with a novel structure. The rotating packed bed includes a housing, a driving mechanism arranged on an upper end surface of the housing, a gas inlet formed in an outer surface of the housing, a gas outlet and a liquid outlet formed in upper and lower end surfaces of the housing, respectively, and a tubular liquid distributor arranged at a center of the housing. A small centrifugal force is applied to the gas in the bed, such that the gas continues to flow in an axial direction. By arranging baffles along an axial direction, ozone can flow in an S-shaped manner in the bed, which makes a flow mode of the gas in the rotor changed.

### CROSS-REFERENCE TO RELATED APPLICATION

This patent application claims the benefit and priority of Chinese Patent Application No. 202410026911.5 filed with the China National Intellectual Property Administration on Jan. 9, 2024, the disclosure of which is incorporated by reference herein in its entirety as part of the present application.

### TECHNICAL FIELD

The present disclosure relates to the technical field of organic wastewater treatment, and in particular to a rotating packed bed with a novel structure.

### BACKGROUND

As the global water crisis becomes more and more obvious, the availability of fresh water resources has declined, and reuse water has become the main way to alleviate the freshwater crisis. As one of the important sources of reuse water, organic wastewater has the characteristics of high organic matter content (COD_{Cr}≥2000 mg/L), complex composition, large chromaticity and odor, and difficulty to biodegrade.

Advanced oxidation process (AOPs) can be used to treat the reuse water of organic wastewater. On the one hand, the removal of refractory organic matters in the reuse water can be achieved; on the other hand, the biodegradability of pollutants in the water can be improved to improve the treatment effect.

Ozone oxidation has the characteristics of high degradation efficiency and no secondary pollution, and its process includes two parts: direct reaction and indirect reaction. The direct reaction of ozone has high selectivity and low reaction rate, while indirect reaction can produce non-selective hydroxyl radicals, which can react with most organic matters and completely mineralize the organic matters into carbon dioxide and water, with better oxidation ability and reaction speed. Therefore, the key problem of degrading organic pollutants is how to produce more active and non-selective ·OH.

In recent years, the catalytic ozone oxidation technology has been widely studied and applied because of its strong oxidation ability, effective reduction of ozone dosage and improvement of mineralization rate of organic matters. Catalysts used in the catalytic ozone oxidation technology can be divided into two categories: homogeneous catalysts and heterogeneous catalysts. The catalysts for heterogeneous ozone catalysis mainly include solid metals, metal oxides, metals or metal oxides carried on carriers, and natural minerals. Compared with the homogeneous catalysts, the heterogeneous catalysts have the characteristics of easy separation and good reusability, which not only avoids the loss of catalysts and environmental pollution, but also reduces the cost of water treatment. Therefore, the heterogeneous catalysts have a good development prospect in the field of advanced wastewater treatment.

However, as the ozone is less dissolved in a liquid phase and mass transfer is limited at the gas-liquid interface, a reaction apparatus with high shear, strong turbulence and capability of increasing the contact area between gas and liquid phases and strengthening the mass transfer of the ozone is adopted to strengthen heterogeneous catalytic ozone oxidation process and improve gas-liquid mass transfer. High gravity technology (Higee) is a novel chemical process intensification technology. In the process of multi-phase contact reaction, the high-gravity device simulates a high-gravity field by generating a centrifugal force from the high-speed rotating rotor. The liquid is sheared into liquid micro-elements (liquid film, liquid droplets, and liquid filaments) under the conditions of high dispersion, high turbulent motion, strong mixing and easy interface renewal, which changes the flow pattern of the multi-phase interface and increases the contact surface between phases. The liquid micro-elements continuously and rapidly undergo multiple processes of coagulation and dispersion, and the reactants are in contact with each other at a great relative speed, such that the gas-liquid/liquid-liquid mixing is improved. However, due to the short axial distance of the high-gravity device and the short residence time of the gas in the bed, the utilization rate of ozone needs to be further improved.

### SUMMARY

The present disclosure provides a rotating packed bed with a novel structure, which solves the problems of high energy consumption caused by situations that the gas entering the bed cannot easily flow in the bed, the ozone stays in the bed for a short time, and the utilization rate of ozone is low.

The technical solution of the present disclosure is as follows: a rotating packed bed with a novel structure includes a housing. A driving mechanism is arranged on an upper end surface of the housing, a gas inlet is formed in an outer surface of the housing, a gas outlet is formed in the upper end surface of the housing, and a liquid outlet is formed in a lower end surface of the housing.

A tubular liquid distributor is arranged at a center of the housing; multiple spouts are formed in a surface of the tubular liquid distributor, and multiple driven mechanisms are arranged on an inner wall of the housing; one end of each of the multiple driven mechanisms is fixedly connected to an annular packing support frame, and the tubular liquid distributor is located at a center of the annular packing support frame; a heterogeneous catalyst is arranged in the annular packing support frame, and a linkage mechanism is arranged at the center of the annular packing support frame.

Multiple baffles are fixedly connected to an inner wall of the annular packing support frame.

Further, multiple retaining rings are welded to the outer surface of the housing, multiple support columns for supporting and fixing are fixedly connected to a surface of one of the multiple retaining rings, and one end of each of the multiple support columns is provided with a non-slip gasket.

Further, the driving mechanism includes a mounting frame fixedly connected to the upper end surface of the housing, a transmission motor fixedly connected to one side of the mounting frame, a connecting port formed in a center of the upper end surface of the housing, and a sealing bearing fixedly connected to an inner wall of the connecting port.

Further, each of the multiple driven mechanisms includes an annular slide rail fixedly connected to an inner surface of the housing, a slide member movably connected into the annular slide rail, lubricating oil paste arranged in the annular slide rail, and multiple connecting rods fixedly connected on one side of the slide member.

One end of each of the multiple connecting rods is fixedly connected to the annular packing support frame, and a cross section of the slide member is I-shaped.

Further, the linkage mechanism includes an internal gear fixedly connected to one side of the annular packing support frame, a transmission shaft fixedly connected to an output end of the driving mechanism, and a transmission gear fixedly connected to one end of the transmission shaft.

The transmission gear is meshed with the internal gear.

Further, multiple openings are formed in each of upper and lower end surfaces of the annular packing support frame, and one side, adjacent to the tubular liquid distributor, of the annular packing support frame is provided with multiple liquid inlets.

Further, a clamping hole is formed in an end surface of each of the multiple retaining rings, a reinforcing rod, which is made of a material with toughness, is clamped by an inner wall of the clamping hole.

Further, corners of the outer surface of the housing are chamfered, a chamfered surface of the housing is bonded with a rubber gasket, and the outer surface of the housing is sprayed with protective paint.

Further, the baffles include two outer rings and one inner ring, an outer diameter of each of the two outer rings is equal to an outer diameter of the annular packing support frame, and an inner diameter of each of the two outer rings is ⅓-½ of the outer diameter of the annular packing support frame; an outer diameter of the inner ring is ½-⅔ of the outer diameter of the annular packing support frame, and an inner diameter of the inner ring is equal to an inner diameter of the annular packing support frame; the inner ring is arranged between the two outer rings, a distance between the inner ring and any one of the two outer rings is ¼-⅓ of the outer diameter of the annular packing support frame, and the two outer rings are consistent in size, but not in position.

Further, a polytetrafluoroethylene sealing ring is arranged between the housing and the liquid outlet, and another polytetrafluoroethylene sealing ring is arranged between the tubular liquid distributor and the gas outlet.

The working principle and beneficial effects of some embodiments are as follows:

1. According to some embodiments, the rotating packed bed is reasonable in structure, and a small centrifugal force is applied to the gas in the bed, such that the gas continues to flow in an axial direction. By arranging baffles along an axial direction, ozone can flow in an S-shaped manner in the bed, which makes a flow mode of the gas in the rotor changed. Meanwhile, the turbulence degree of the gas in the bed is improved, which makes the gas form local vortex and forced turbulence near the plate, so that the residence time of ozone in the bed is improved by about 20%. The gas-liquid contact is improved, and the utilization rate of ozone is further improved, thus achieving the purpose of reducing energy consumption and making the organic wastewater discharge up to the standard.

2. The transmission shaft is driven by the transmission motor, so that the transmission gear is driven to rotate, while the transmission gear is meshed with the internal gear for rotation, such that the annular packing support frame can slide in the annular slide rail through the connecting rod and the slide member, and the rotation stability of the annular packing support frame is achieved.

3. The housing is supported and fixed by the retaining ring and the support columns, and the surface of the housing is protected by a reinforcing rod between the two retaining rings, thus avoiding the problem that the housing is damaged due to external collision during use.

### BRIEF DESCRIPTION OF THE DRAWINGS

The present disclosure is further described in detail below with reference to accompanying drawings and specific embodiments.

FIG. 1 is a first schematic diagram of a three-dimensional structure according to the present disclosure;

FIG. 2 is a second schematic diagram of a three-dimensional structure according to the present disclosure;

FIG. 3 is a schematic diagram of a cross-sectional structure according to the present disclosure;

FIG. 4 is a schematic diagram of an enlarged structure at part A in FIG. 3;

FIG. 5 is a schematic diagram of an enlarged structure at part B in FIG. 3;

FIG. 6 is a schematic diagram of application of the present disclosure.

In the drawings: 1 housing; 2 transmission motor; 3 mounting frame; 4 retaining ring; 5 reinforcing rod; 6 support column; 7 tubular liquid distributor; 8 liquid outlet; 9 gas inlet; 10 non-slip gasket; 11 gas outlet; 12 sealing bearing; 13 annular packing support frame; 14 baffle; 15 opening; 16 liquid inlet; 17 annular slide rail; 18 slide member; 19 connecting rod; 20 transmission shaft; 21 internal gear; 22 transmission gear.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

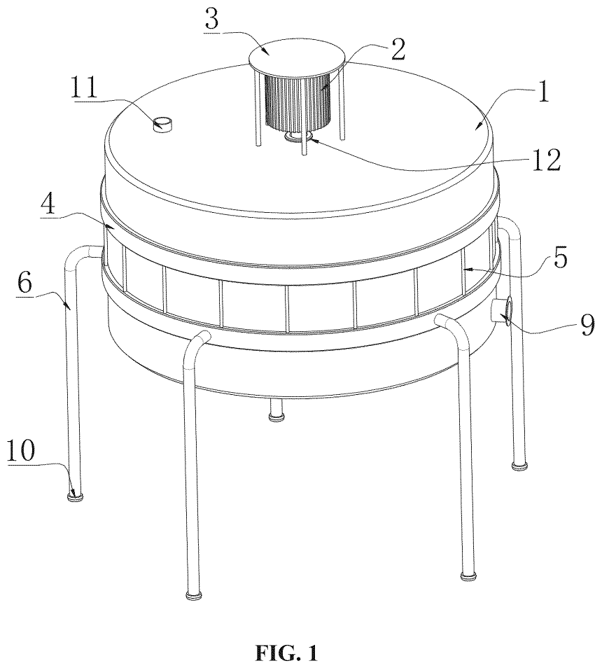

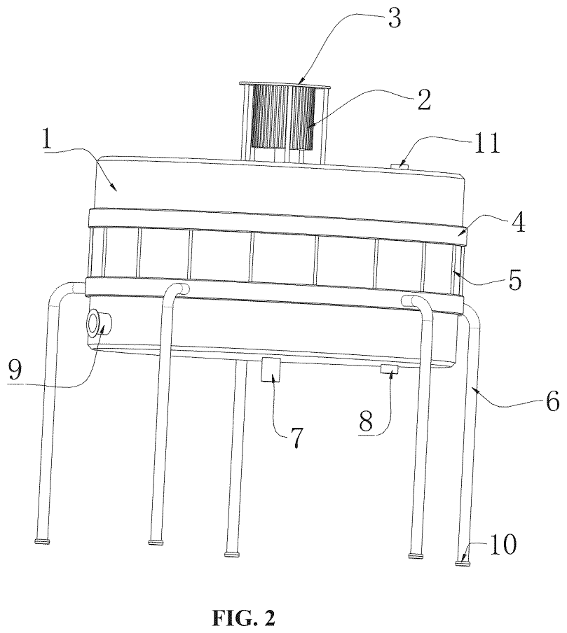

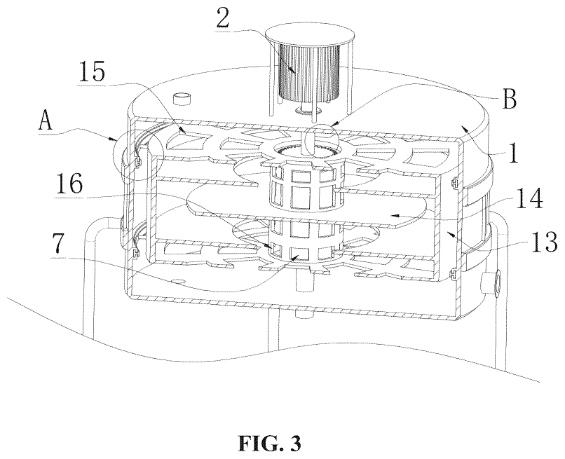

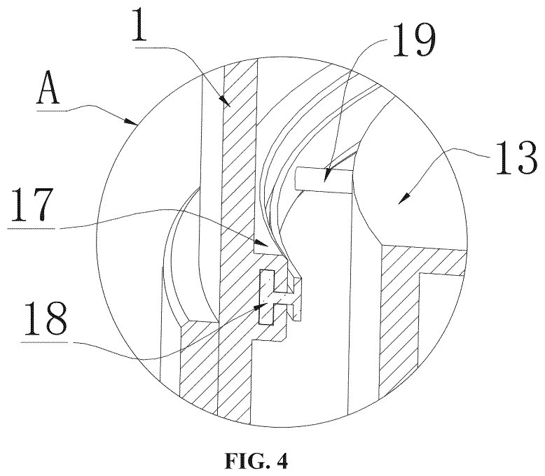

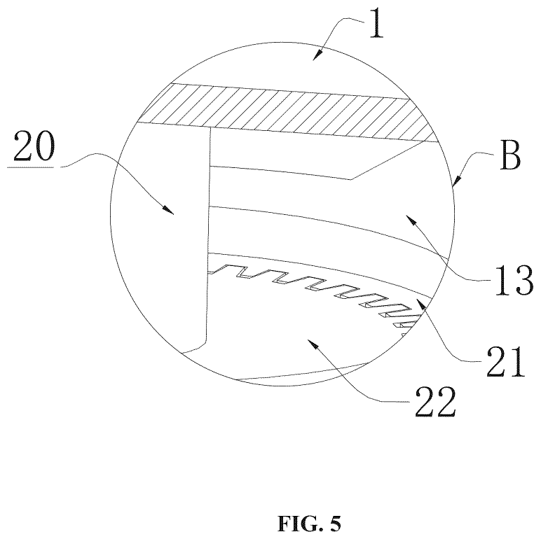

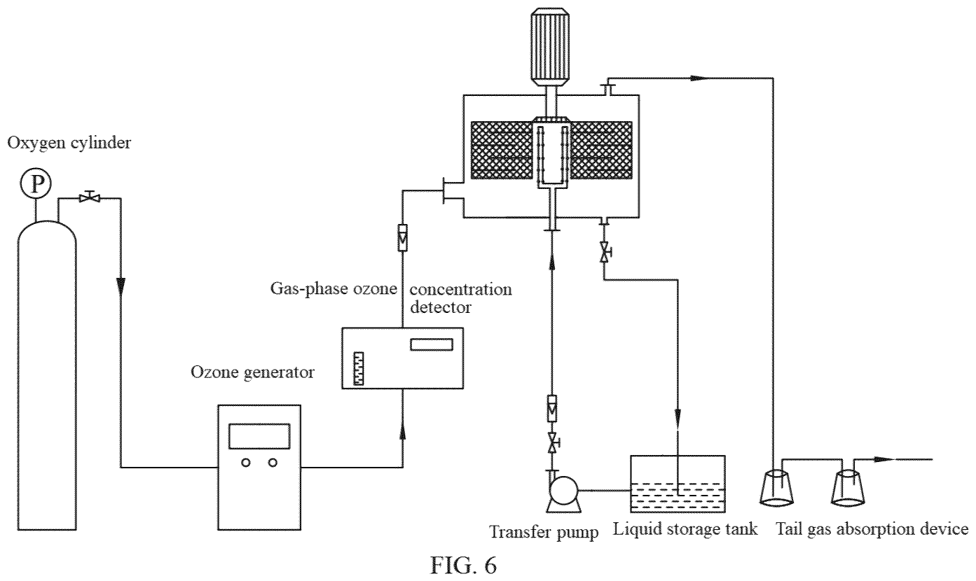

Please referring to FIG. 1 to FIG. 6, the present disclosure provides a technical solution of a rotating packed bed with a novel structure, including a housing 1. A driving mechanism is arranged on an upper end surface of the housing 1, a gas inlet 9 is formed in an outer surface of the housing 1, and a gas outlet 11 and a liquid outlet 8 are formed in upper and lower end surfaces of the housing 1, respectively.

A tubular liquid distributor 7 is arranged at the center of the housing 1. Multiple spouts are formed in a surface of the tubular liquid distributor 7, and multiple driven mechanisms are arranged on an inner wall of the housing 1. One end of each driven mechanism is fixedly connected to an annular packing support frame, and the tubular liquid distributor 7 is located at the center of the annular packing support frame 13. A heterogeneous catalyst is arranged in the annular packing support frame 13, and a linkage mechanism is arranged at the center of the annular packing support frame 13.

Multiple baffles 14 are fixedly connected to an inner wall of the annular packing support frame 13.

According to the present disclosure, a gas mixture of ozone and oxygen generated by oxygen passing through an ozone generator enters the annular packing support frame 13 through a pipeline and the gas inlet 9 at a gas flow rate of 60 L/h, and meanwhile, 1 L of raw water of pesticide salty organic wastewater is poured into a liquid storage tank, and enters the annular packing support frame 13 from the tubular liquid distributor 7 at a flow rate of 60 L/h through a transfer pump and a liquid flowmeter. The liquid sprayed by the tubular liquid distributor 7 enters the annular packing support frame 13 to make full contact with the ozone gas. A high-gravity factor is set to 30. In this case, the linkage mechanism is driven by the driving mechanism, such that a centrifugal force is generated by the high-speed rotation of the annular packing support frame 13 to replace gravitational acceleration and make mixed liquid flow from the center to the outer edge in the bed. Meanwhile, the packing in the annular packing support frame 13 is configured to quickly shear the flowing liquid, and the gas and liquid are fully mixed and reacted in the high-gravity rotating packed bed. The unreacted gas is absorbed by a potassium iodide (KI) solution with a concentration of 5% and then discharged. The liquid, after being converged, passes through the liquid outlet 8 to enter a liquid storage tank for the next cycle, and the cycle is ended after 15 min minutes of reaction.

Noted: after the wastewater from pesticide production with a COD (chemical oxygen demand) of 300-400 mg/L reacts for 15 min under the conditions that the high-gravity factor is 30, a liquid flow rate is 60 L/h, a liquid-gas ratio is 1:1 and an ozone concentration is 20 mg/L, the COD value is reduced to 130-160 mg/L, and the degradation rate exceeds 60%, and thus the discharge standard of pesticide organic wastewater is satisfied.

Preferably, multiple retaining rings 4 are welded to an outer surface of the housing 1, multiple support columns 6 for supporting and fixing are fixedly connected to a surface of one retaining ring 4, and one end of each support column 6 is provided with a non-slip gasket 10. A clamping hole is formed in an end surface of the retaining ring 4, and a reinforcing rod 5 made of a material with toughness is clamped by an inner wall of the clamping hole.

Specifically, the housing 1 is supported and fixed by the retaining rings 4 and the support columns 6, and the surface of the housing 1 is protected by the reinforcing rod 5 between the two retaining rings 4.

Preferably, the driving mechanism includes a mounting frame 3 fixedly connected to the upper end surface of the housing 1, a transmission motor 2 fixedly connected to one side of the mounting frame 3, a connecting port formed in the center of the upper end surface of the housing 1, and a sealing bearing 12 fixedly connected to an inner wall of the connecting port. The driven mechanism includes an annular slide 17 fixedly connected to an inner surface of the housing 1, a slide member 18 movably connected into the annular slide rail 17, lubricating oil paste arranged in the annular slide rail 17, and multiple connecting rods 19 fixedly connected to the one side of the slide member 18.

One end of each connecting rod 19 is fixedly connected to the annular packing support frame 13, and the cross section of the slide member 18 is I-shaped.

The linkage mechanism includes an internal gear 21 fixedly connected to one side of the annular packing support frame 13, a transmission shaft 20 fixedly connected to an output end of the driving mechanism, and a transmission gear 22 fixedly connected to one end of the transmission shaft 20.

The transmission gear 22 is meshed with the internal gear 21.

Specifically, the transmission shaft 20 is driven by the transmission motor 2, so that the transmission gear 22 is driven to rotate, while the transmission gear 22 is meshed with the internal gear 21 for rotation, such that the annular packing support frame 13 can slide in the annular slide rail 17 through the connecting rod 19 and the slide member 18.

Preferably, multiple openings 15 are formed in each of upper and lower end surfaces of the annular packing support frame 13, and multiple liquid inlets 16 are formed in one side, adjacent to the tubular liquid distributor 7, of the annular packing support frame 13. Corners of the outer surface of the housing 1 are chamfered, a chamfered surface of the housing 1 is bonded with a rubber gasket, and the surface of the housing 1 is sprayed with protective paint. A polytetrafluoroethylene sealing ring is arranged between the housing 1 and the liquid outlet 8, and another polytetrafluoroethylene sealing ring is arranged between the tubular liquid distributor 7 and the gas outlet 11.

Preferably, the baffles 14 include two outer rings and one inner ring. The outer diameter of each of the two outer rings is equal to an outer diameter is an outer diameter of the annular packing support frame 13, and an inner diameter of each of the two outer rings is ⅓-½ of the outer diameter of the annular packing support frame 13. The outer diameter of the inner ring is ½-⅔ of the outer diameter of the annular packing support frame 13, and an inner diameter of the inner ring is equal to an inner diameter of the annular packing support frame 13. The inner ring is arranged between the two outer rings, a distance between the inner ring and any one of the two outer rings is ¼-⅓ of the outer diameter of the annular packing support frame 13, and the two outer rings of the three baffles 14 are consistent in size, but not in position.

The working principle and use flow of the present disclosure are as follows: when in use, the gas inlet 9 is connected to an oxygen cylinder, an ozone generator and a gas-phase ozone concentration detector through pipelines, respectively, and the tubular liquid distributor 7 is connected to a transfer pump through a pipeline, such that the liquid in the liquid storage tank can be transported to the tubular liquid distributor 7. Afterwards, the liquid outlet 8 is connected to a liquid storage tank through a pipeline, and finally the gas outlet 11 is connected to a gas recovery device through a pipeline, and thus the installation work before use can be completed.

A gas mixture of ozone and oxygen generated by oxygen passing through an ozone generator enters the annular packing support frame 13 through a pipeline and the gas inlet 9 at the gas flow rate of 60 L/h, and meanwhile, 1 L of raw water of pesticide salty organic wastewater is poured into a liquid storage tank, and enters the annular packing support frame 13 from the tubular liquid distributor 7 at a flow rate of 60 L/h through a transfer pump and a liquid flowmeter. The liquid sprayed by the tubular liquid distributor 7 enters the annular packing support frame 13 to make full contact with the ozone gas. A high-gravity factor is set to 30. In this case, the transmission shaft 20 is driven by the transmission motor 2 to rotate, so that the transmission gear 22 is driven to rotate, while the transmission gear 22 is meshed with the internal gear 21 for rotation, such that the annular packing support frame 13 can slide in the annular slide rail 17 through the connecting rod 19 and the slide member 18, and the rotation stability of the annular packing support frame 13 is achieved. Moreover, a centrifugal force is generated by the high-speed rotation of the annular packing support frame 13 to replace gravitational acceleration and make mixed liquid flow from the center to the outer edge in the bed. Meanwhile, the packing in the annular packing support frame 13 is configured to quickly shear the flowing liquid, such that the gas and liquid are fully mixed and reacted in the high-gravity rotating packed bed. The unreacted gas is absorbed by a potassium iodide (KI) solution with a concentration of 5% and then discharged. The liquid, after being converged, passes through the liquid outlet 8 to enter a liquid storage tank for the next cycle, and the cycle is ended after 15 min minutes of reaction.

The above is only the preferred embodiment of the present disclosure, and is not used to limit the present disclosure. Any modification, equivalent replacement, improvement, etc. made within the spirit and principle of the present disclosure should be included in the scope of protection of the present disclosure.

What is claimed is:

1. A rotating packed bed with a novel structure, comprising
a housing having an upper end surface, a lower end surface, an outer surface and an inner wall;
a driving mechanism arranged on the upper end surface of the housing,
a gas inlet formed in the outer surface of the housing,
a gas outlet formed in the upper end surface of the housing,
a liquid outlet formed in the lower end surface of the housing;
a tubular liquid distributor arranged at a center of the housing, the tubular liquid distributor having a plurality of spouts formed in a surface thereof; and
a plurality of driven mechanisms arranged on the inner wall of the housing where one end of each of the plurality of driven mechanisms is fixedly connected to an annular packing support frame, and the tubular liquid distributor is located at a center of the annular packing support frame;
a heterogeneous catalyst is arranged in the annular packing support frame, and a linkage mechanism is arranged at the center of the annular packing support frame; and
a plurality of baffles are fixedly connected to an inner wall of the annular packing support frame.

2. The rotating packed bed with a novel structure according to claim 1, further comprising:
a plurality of retaining rings welded to the outer surface of the housing,
a plurality of support columns for supporting and fixing are fixedly connected to a surface of one of the plurality of retaining rings, and one end of each of the plurality of support columns is provided with a non-slip gasket.

3. The rotating packed bed with a novel structure according to claim 1, wherein the driving mechanism comprises:
a mounting frame fixedly connected to the upper end surface of the housing;
a transmission motor fixedly connected to one side of the mounting frame;
a connecting port formed in a center of the upper end surface of the housing; and
a sealing bearing fixedly connected to an inner wall of the connecting port.

4. The rotating packed bed with a novel structure according to claim 1, wherein each of the plurality of driven mechanisms comprises:
an annular slide rail fixedly connected to an inner surface of the housing;
a slide member movably connected into the annular slide rail, a cross section of the slide member being I-shaped;
lubricating oil paste arranged in the annular slide rail; and
a plurality of connecting rods fixedly connected on one side of the slide member, where one end of each of the plurality of connecting rods (19) is fixedly connected to the annular packing support frame.

5. The rotating packed bed with a novel structure according to claim 1, wherein the linkage mechanism comprises:
an internal gear fixedly connected to one side of the annular packing support frame,
a transmission shaft fixedly connected to an output end of the driving mechanism, and
a transmission gear fixedly connected to one end of the transmission shaft; and the transmission gear is meshed with the internal gear.

6. The rotating packed bed with a novel structure according to claim 1, wherein a plurality of openings are formed in each of upper and lower end surfaces of the annular packing support frame, and one side, adjacent to the tubular liquid distributor, of the annular packing support frame is provided with a plurality of liquid inlets.

7. The rotating packed bed with a novel structure according to claim 2, wherein a clamping hole is formed in an end surface of each of the plurality of retaining rings, a reinforcing rod, which is made of a material with toughness, is clamped by an inner wall of the clamping hole.

8. The rotating packed bed with a novel structure according to claim 1, wherein corners of the outer surface of the housing are chamfered, a chamfered surface of the housing is bonded with a rubber gasket, and the outer surface of the housing is sprayed with protective paint.

9. The rotating packed bed with a novel structure according to claim 1, wherein the baffles comprise two outer rings and one inner ring,
an outer diameter of each of the two outer rings is equal to an outer diameter of the annular packing support frame, and
an inner diameter of each of the two outer rings is ⅓-½ of the outer diameter of the annular packing support frame;
an outer diameter of the inner ring is ½-⅔ of the outer diameter of the annular packing support frame, and an inner diameter of the inner ring is equal to an inner diameter of the annular packing support frame;
the inner ring is arranged between the two outer rings, a distance between the inner ring and any one of the two outer rings is ¼-⅓ of the outer diameter of the annular packing support frame, and the two outer rings are consistent in size, but not in position.

10. The rotating packed bed with a novel structure according to claim 1, further comprising a polytetrafluoroethylene sealing ring is arranged between the housing and the liquid outlet, and another polytetrafluoroethylene sealing ring is arranged between the tubular liquid distributor and the gas outlet.
